(19) United States
(12) Patent Application Publication
(10) Pub. No.: US 2019/0168285 A1
(43) Pub. Date: Jun. 6, 2019

(54) METHOD FOR MANUFACTURING RING

(71) Applicant: AISIN AW CO., LTD., Anjo-shi, Aichi-ken (JP)

(72) Inventor: Takashi OBAYASHI, Anjo (JP)

(73) Assignee: AISIN AW CO., LTD., Anjo-shi, Aichi-ken (JP)

(21) Appl. No.: 16/324,221

(22) PCT Filed: Sep. 29, 2017
(86) PCT No.: PCT/JP2017/035644

§ 371 Date: Feb. 8, 2019

(30) Foreign Application Priority Data
Sep. 30, 2016 (JP) 2016-193908

(51) Int. Cl. B21D 53/16; B23K 26/38; B24B 9/04

(52) U.S. Cl. CPC B21D 53/16; F16G 5/16; B24B 9/04; B23K 26/38

(57) ABSTRACT

This method for manufacturing a ring is a method for manufacturing an endless metal ring for a continuously variable transmission using a transmission belt that is formed by binding a plurality of elements with the ring. The method includes: a welding step of butt welding ends of a metal strip to form an endless tubular body; a solution treatment step of solution-treating the welded tubular body; a cutting step of cutting the solution-treated tubular body with laser light into ring bodies with a predetermined width; a lateral end processing step of pressing a grinding wheel against a lateral end of the cut ring body to remove a heat-affected zone formed by the cutting step and form the lateral end into a convex arc shape; and a rolling step of adjusting the ring body with the processed lateral end to a predetermined thickness.

### CROSS REFERENCE TO RELATED APPLICATIONS

This application is a National Stage of International Application No. PCT/JP2017/035644, filed Sep. 29, 2017, claiming priority based on Japanese Patent Application No. 2016-193908, filed Sep. 30, 2016.

### TECHNICAL FIELD

The various aspects of the present disclosure disclosed in the specification relates to methods for manufacturing a ring.

### BACKGROUND ART

Conventionally, methods including a welding step of butt welding ends of a metal strip to form an endless tubular body, a solution treatment step of solution-treating (annealing) the welded tubular body, and a cutting step of cutting the solution-treated tubular body with laser light into ring bodies with a predetermined width have been proposed as methods for manufacturing a ring for a belt-type continuously variable transmission using an annular transmission belt that is formed by binding a multiple elements with the ring (see, e.g., Patent Document 1).

Patent Document 1: Japanese Patent Application Publication No. 2002-248522 (JP 2002-248522 A)

### SUMMARY

In the above methods for manufacturing a ring, when the tubular body is cut with laser light, the ring body is structurally changed (heat-affected zones) due to heat of the laser light, which affect plastic workability of the ring body in the subsequent steps. For example, the ring body may break or may not be able to be formed to predetermined dimensions when performing a rolling step of rolling the laser cut ring body and when performing a circumference adjusting step of adjusting the ring bodies to their required circumferences in order to laminate a plurality of the ring bodies in the radial direction to form a laminated ring. Solution treatment needs therefore to be performed again after the laser cutting.

It is an aspect of the present disclosure to enhance ring manufacturing efficiency by efficiently removing heat-affected zones formed in a ring body by laser cutting.

The embodiments of the present disclosure has taken the following measures in order to achieve the above primary object.

A method for manufacturing a ring according to the present disclosure is a method for manufacturing an endless metal ring for a continuously variable transmission using a transmission belt that is formed by binding a plurality of elements with the ring. The method includes: a welding step of butt welding ends of a metal strip to form an endless tubular body; a solution treatment step of solution-treating the welded tubular body; a cutting step of cutting the solution-treated tubular body with laser light into ring bodies with a predetermined width; a lateral end processing step of pressing a grinding wheel against a lateral end of the cut ring body to remove a heat-affected zone formed by the cutting step and form the lateral end into a convex arc shape; and a rolling step of adjusting the ring body with the processed lateral end to a predetermined thickness.

In the method for manufacturing a ring according to the present disclosure, after the welding step of forming the endless tubular body, the first solution treatment step of solution-treating the tubular body, and the cutting step of cutting the tubular body into ring bodies by laser cutting are performed, the heat-affected zone formed by the laser cutting is also removed when the lateral end of the ring body is formed into a convex arc shape by the lateral end processing step. No heat-affected zone with high hardness therefore remains in the ring body after the lateral end processing step. This can eliminate the need to subsequently perform the first solution treatment step again and thus can improve ring manufacturing efficiency. After the cutting step is performed with laser light, the heat-affected zone formed in the lateral end of the ring body by the laser cutting is also removed when the lateral end is processed into a convex arc shape by the lateral end processing step. Accordingly, even in the case where a cutting machine that is used in the cutting step is switched from other cutting machine such as a cutter cutting machine to a laser cutting machine, the existing facilities can be effectively used, and additions and changes to manufacturing facilities can be minimized.

### BRIEF DESCRIPTION OF THE DRAWINGS

FIG. 1 is a configuration diagram schematically showing the configuration of a continuously variable transmission 1.

FIG. 2 is a configuration diagram schematically showing the configuration of a transmission belt 10.

FIGS. 3A to 3M are illustrations showing an example of a manufacturing process of a ring.

FIG. 4 is a partial enlarged view showing a laser cut portion in a lateral section of a ring body 23.

FIG. 5 is an illustration showing the relationship between the lateral distance from a laser cut surface of the ring body 23 and the hardness.

FIGS. 6A and 6B are illustration showing a polishing and rounding step.

FIG. 7 is a configuration diagram schematically showing the configuration of a polishing apparatus 30.

FIGS. 8A to 8C are illustrations showing how the outer peripheral side of an end of the ring body 23 is polished and rounded by using an outer peripheral-side polishing roll 41.

FIGS. 9A to 9C are illustrations showing how the inner peripheral side of the end of the ring body 23 is polished and rounded by using an inner peripheral-side polishing roll 46.

FIGS. 10A to 10D are illustrations showing how a lateral end of a ring body 23 is polished and rounded by using a polishing roll 41B of a comparative example.

FIG. 11 is a configuration diagram schematically showing the configuration of a polishing apparatus 130 of another embodiment.

FIGS. 12A to 12C are illustrations showing how a lateral end of a ring body 23 is polished and rounded by using a polishing roll 141.

### PREFERRED EMBODIMENTS

Modes for carrying out the various aspects of the present disclosure will be described below with reference to the accompanying drawings.

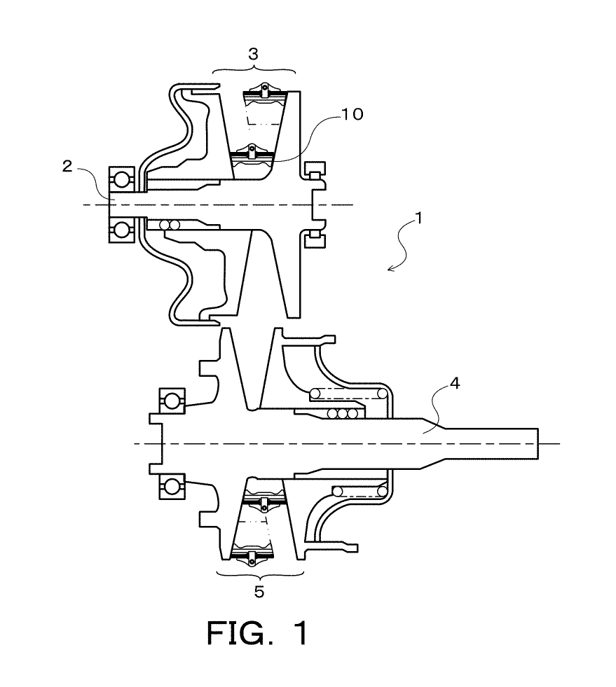

FIG. 1 is a configuration diagram schematically showing the configuration of a continuously variable transmission 1. The continuously variable transmission 1 is mounted on a vehicle including a power source such as an engine, and as shown in the figure, includes a primary shaft 2 serving as a drive-side rotary shaft, a primary pulley 3 provided on the primary shaft 2, a secondary shaft 4 disposed parallel to the primary shaft 2 and serving as a driven-side rotary shaft, a secondary pulley 5 provided on the secondary shaft 4, and a transmission belt 10 wound around a pulley groove (V-groove) of the primary pulley 3 and a pulley groove (V-groove) of the secondary pulley 5. The continuously variable transmission 1 changes the groove widths of the primary pulley 3 and the secondary pulley 5 and thus steplessly shifts power of the primary pulley 3 to transmit the shifted power to the secondary pulley 5.

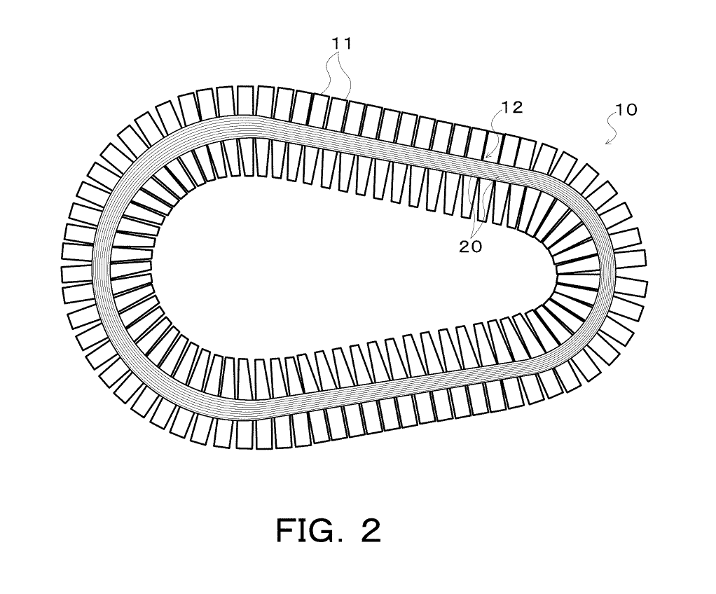

FIG. 2 is a configuration diagram schematically showing the configuration of the transmission belt 10. As shown in FIG. 2, the transmission belt 10 includes a multiple (e.g., several hundreds) elements 11 and a laminated ring 12 and is formed by binding the multiple elements 11 into a ring shape with the laminated ring 12. For example, the elements 11 are parts punched out from a steel sheet by pressing. The elements 11 are subjected to a clamping force from the pulley (the primary pulley 3, the secondary pulley 5) at their right and left side surfaces, and those elements 11 which are located ahead in the traveling direction of the belt are pushed out by the friction force in a direction tangential to the pulley, whereby power is transmitted.

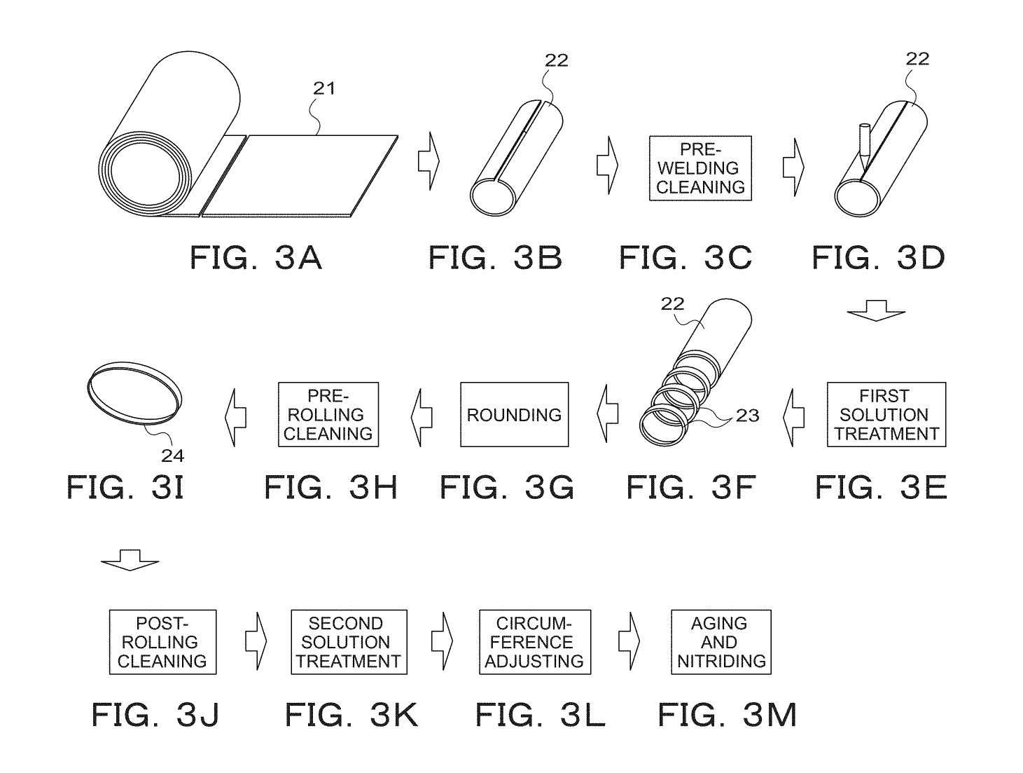

The laminated ring 12 is formed by laminating a plurality of endless metal rings 20 (single rings) having slightly different circumferences from each other in the radial direction. The laminated ring 12 is manufactured by a manufacturing process illustrated in FIGS. 3A to 3M.

As shown in FIG. 3, the manufacturing process of the ring 20 is comprised of (A) a strip cutting step (see FIG. 3A), (B) a bending step (see FIG. 3B), (C) a pre-welding cleaning step (see FIG. 3C), (D) a welding step (see FIG. 3D), (E) a first solution treatment step (annealing step) (see FIG. 3E), (F) a ring cutting step (see FIG. 3F), (G) a polishing and rounding step (see FIG. 3G), (H) a pre-rolling cleaning step (see FIG. 3H), (I) a rolling step (see FIG. 31), (J) a post-rolling cleaning step (see FIG. 3J), (K) a second solution treatment step (see FIG. 3K), (L) a circumference adjusting step (see FIG. 3L), and (M) an aging and nitriding step (see FIG. 3M).

The strip cutting step (A) is a step of cutting a strip steel (maraging steel) having a predetermined thickness (e.g., 0.4 to 0.5 mm) and wound around a drum in the lateral direction into strips 21 with a predetermined size. The strip cutting step can be performed by using a cutter cutting machine having a cutter edge, a laser cutting machine, etc. The bending step (B) is a step of forming a tubular body 22 by bending the strip 21 into a tubular shape such that the ends of the strip 21 abut on each other. The bending step can be performed by using a roll or a die.

The pre-welding cleaning step (C) is a step of degreasing and cleaning the tubular body 22 before welding the abutting portions of the tubular body 22. The pre-welding cleaning step can be performed by, e.g., shower cleaning, ultrasonic cleaning, etc. The welding step (D) is a step of performing butt welding, namely welding the abutting portions of the tubular body 22. The welding step can be performed by, e.g., laser welding, plasma welding, etc. The first solution treatment step (annealing step) (E) is a step that is performed in order to level hardness distribution around the weld, which has been changed by the welding step, to improve ductility.

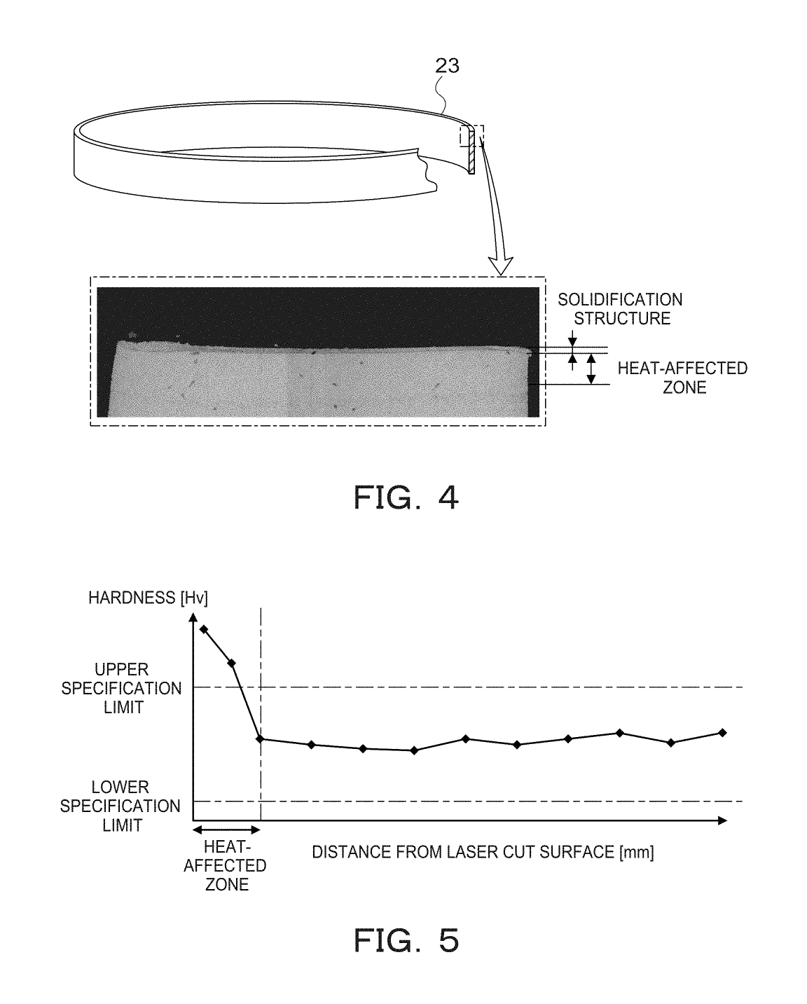

The ring cutting step (F) is a step of cutting the tubular body 22 into a plurality of ring bodies 23 with a predetermined width, and this step is performed by using a laser cutting machine. FIG. 4 is a partial enlarged view showing a laser cut portion in a lateral section of the ring body 23. As shown in the figure, the laser cut portion includes a solidification structure where metal melted by heat from laser light has solidified and a heat-affected zone (HAZ) where structural changes have occurred due to the heat. FIG. 5 is an illustration showing the relationship between the lateral distance from a laser cut surface of the ring body 23 and the hardness. As shown in the figure, the hardness of the heat-affected zone is significantly different from the hardnesses of portions far away from the laser cut surface and hardly affected by the heat. If the rolling step (I) is performed with the heat-affected zones remaining in the ring body 23, the ring body 23 may break from the heat-affected zones with high hardness or may not be able to be formed to intended dimensions due to the difference in deformation resistance.

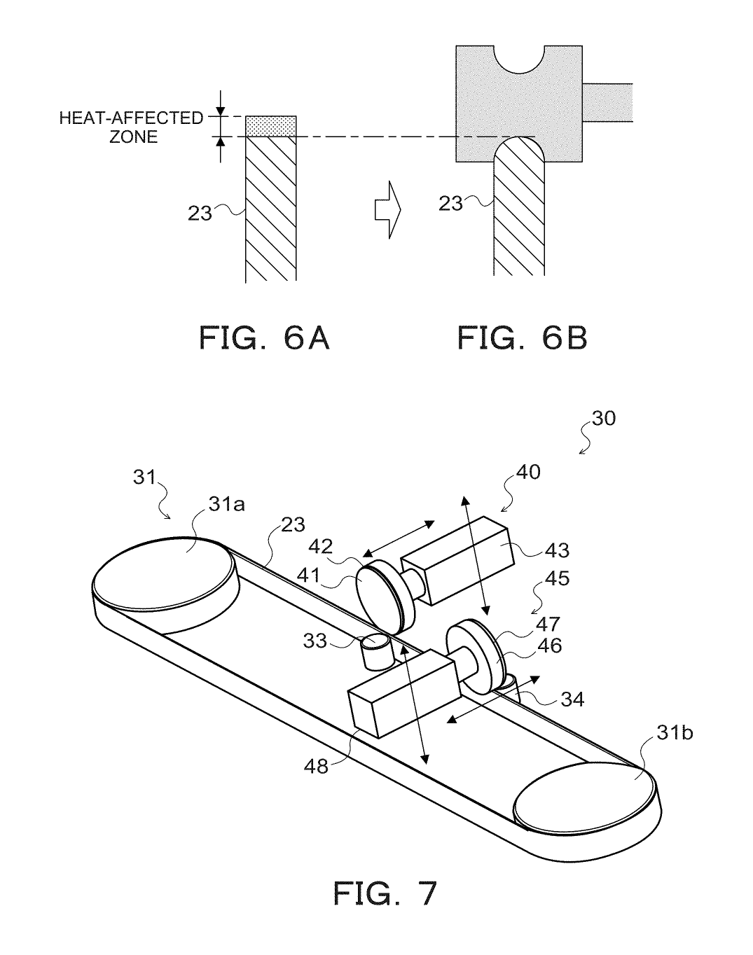

As shown in FIGS. 6A and 6B, the polishing and rounding step (G) is a step of polishing lateral end (laser cut portions) of the ring body 23 with a polishing roll to remove the heat-affected zones and process the lateral ends of the ring body 23 into a convex arc shape (round shape), and this step is performed by using a polishing apparatus 30 illustrated in FIG. 7. As shown in FIG. 7, the polishing apparatus 30 includes: a rotating unit 31 having a drive roller 31a and a driven roller 31b around which the ring body 23 is wound; an inner peripheral-side backup roller 33 that supports the ring body 23 from the inner peripheral side; an outer peripheral-side polishing unit 40 that faces the inner peripheral-side backup roller 33 and polishes the outer peripheral side of a lateral end (the outer peripheral side of an end) of the ring body 23 into a round shape; an outer peripheral-side backup roller 34 that supports the ring body 23 from the outer peripheral side; and an inner peripheral-side polishing unit 45 that faces the outer peripheral-side backup roller 34 and polishes the inner peripheral side of the lateral end (the inner peripheral side of the end) of the ring body 23 into a round shape. The drive roller 31a being pressed against the inner peripheral surface of the ring body 23 in a direction away from the driven roller 31b is driven to rotate, whereby the rotating unit 31 can rotate (turn) the ring body 23 under tension in the circumferential direction. The rotating unit 31 may include a separate tension roller that tensions the ring body 23. The outer peripheral-side polishing unit 40 includes: an outer peripheral-side polishing roll 41 having an axis of rotation extending in a direction parallel to the thickness direction of the ring body 23 set on the rotating unit 31; and a rotating and moving unit 43 capable of rotating and moving the outer peripheral-side polishing roll 41 in the rotational direction of the outer peripheral-side polishing roll 41, the axial direction of the axis of rotation of the outer peripheral-side polishing roll 41 (forward and backward in the figure), and a direction perpendicular to this axial direction and parallel to the lateral direction of the ring body 23 (upward and downward in the figure). The inner peripheral-side polishing unit 45 includes an outer peripheral-side polishing roll 46 and a rotating and rotating unit 48 which are similar to those of the outer peripheral-side polishing unit 40.

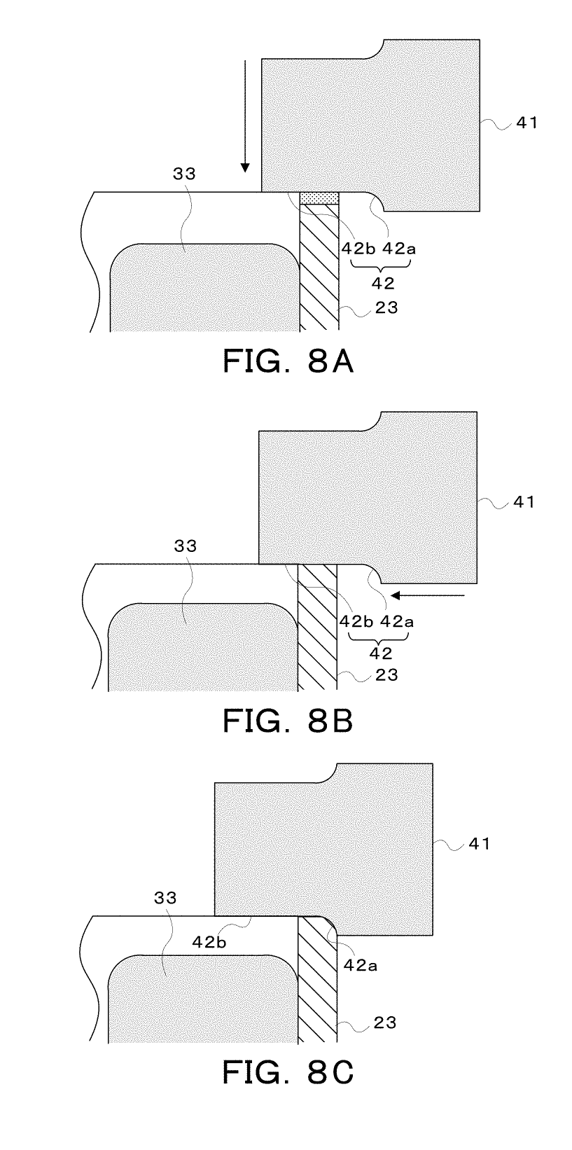

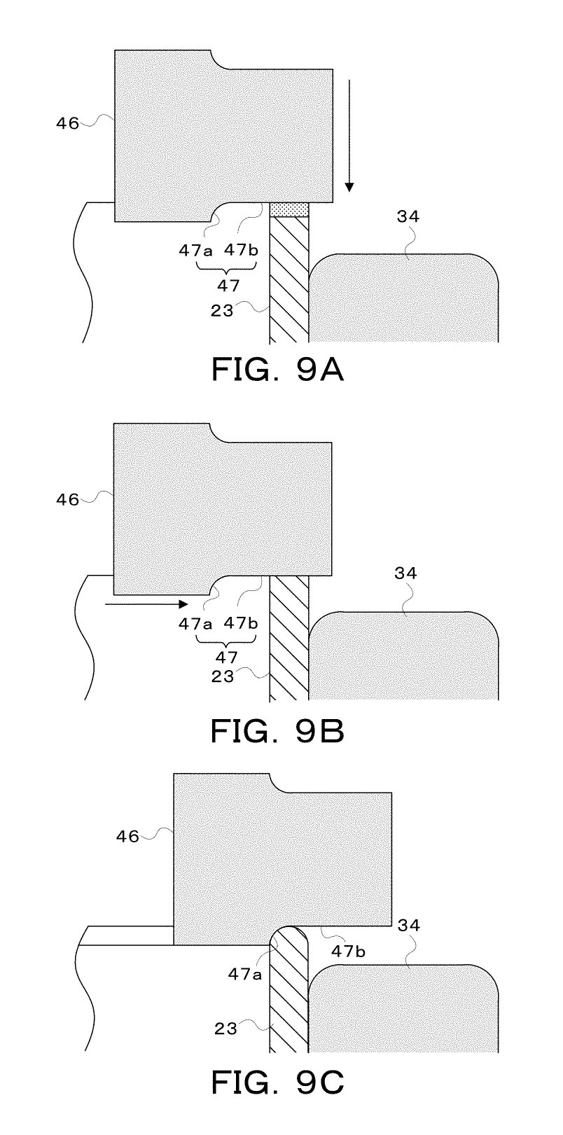

FIGS. 8A to 8C are illustrations showing how the outer peripheral side of an end of the ring body 23 is polished and rounded by using the outer peripheral-side polishing roll 41. FIGS. 9A to 9C are illustrations showing how the inner peripheral side of the end of the ring body 23 is polished and rounded by using the inner peripheral-side polishing roll 46. In FIGS. 8A to 8C and FIGS. 9A to 9C, L-shaped grooves 42, 47 of the outer peripheral-side polishing roll 41 and the inner peripheral-side polishing roll 46 are shown exaggerated for convenience of description. The outer peripheral-side polishing roll 41 and the inner peripheral-side polishing roll 46 are columnar members and have the L-shaped grooves 42, 47 formed in the circumferential direction in the distal end portions of their outer peripheral surfaces along the entire circumference. The bottoms of the L-shaped grooves 42, 47 are formed by linear portions 42b, 47b extending straight in the axial direction of the outer peripheral-side polishing roll 41 and the inner peripheral-side polishing roll 46, and corners of the bottoms of the L-shaped grooves 42, 47 are formed by concave arc-shaped portions 42a, 47a having an arc angle θ of about 90 degrees and a radius of curvature r that is about ½ of the thickness t of the ring body 23. The L-shaped grooves 42, 47 have an abrasive grain layer comprised of abrasive grains bonded together. The ring body 23 is polished and rounded by using the outer peripheral-side polishing roll 41 and the inner peripheral-side polishing roll 46 as follows. First, the outer peripheral-side polishing roll 41 is moved in a direction from one lateral end toward the other lateral end of the ring body 23 (downward in the figure) while being rotated, and the inner peripheral-side polishing roll 46 is moved in the direction from the one lateral end toward the other lateral end of the ring body 23 (downward in the figure) while being rotated. The linear portions 42b, 47b are thus pressed against the end face of the one lateral end of the ring body 23 to remove the heat-affected zone in the one lateral end of the ring body 23 (see FIGS. 8A, 9A). The outer peripheral-side polishing roll 41 is then moved from the outer peripheral side toward the inner peripheral side in the thickness direction of the ring body 23 (to the left in the figure) while being rotated, so that the concave arc-shaped portion 42a is pressed against the outer peripheral side of the one lateral end (the outer peripheral side of the end) of the ring body 23. The outer peripheral side of the end of the ring body 23 is thus formed into a round shape (see FIGS. 8B, 8C). At the same time, the inner peripheral-side polishing roll 46 is moved from the inner peripheral side toward the outer peripheral side in the thickness direction of the ring body 23 (to the right in the figure) while being rotated, so that the concave arc-shaped portion 47a is pressed against the inner peripheral side of the one lateral end (the inner peripheral side of the end) of the ring body 23. The inner peripheral side of the end of the ring body 23 is thus formed into a round shape (see FIGS. 9B, 9C). The outer peripheral side and the inner peripheral side of the end of the ring body 23 need not necessarily be processed at the same time, but may be processed at different timings. That is, the inner peripheral side of the end of the ring body 23 may be processed after the outer peripheral side of the end is processed, or the outer peripheral side of the end of the ring body 23 may be processed after the inner peripheral side of the end is processed. The rotational direction of the outer peripheral-side polishing roll 41 and the inner peripheral-side polishing roll 46 at the contact point with the ring body 23 may be either the same as or opposite to the turning direction of the ring body 23. After the one lateral end of the ring body 23 is thus polished, the ring body 23 is removed from the rotating unit 31 and is mounted again on the rotating unit 31 with its one lateral end and the other lateral end switched, and the other lateral end of the ring body 23 is similarly polished. The heat-affected zones are thus removed from both lateral ends of the ring body 23, and both lateral ends of the ring body 23 are formed into a semicircular shape with almost no edge. The pair of the outer peripheral-side polishing unit 40 and the inner peripheral-side polishing unit 45 may be provided on each of the one lateral end side and the other lateral end side of the ring body 23 so that each of the one lateral end and the other lateral end of the ring body 23 is polished by a corresponding pair of the outer peripheral-side polishing unit 40 and the inner peripheral-side polishing unit 45.

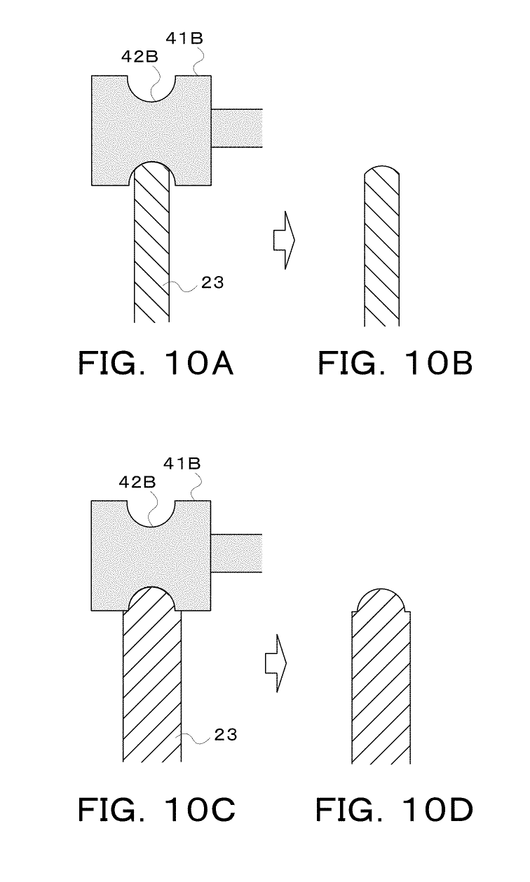

FIGS. 10A to 10D are illustrations showing how a lateral end of the ring body 23 is polished and rounded by using a polishing roll 41B of a comparative example. The polishing roll 41B of the comparative example has a semicircular groove 42B formed in the middle in the axial direction of its outer peripheral surface along the entire circumference, and the semicircular groove 42B has an arc angle θ of about 180 degrees and a radius of curvature r that is about ½of the thickness t of the ring body 23. In the comparative example, the polishing roll 41B is moved in the lateral direction of the ring body 23 while being rotated, so that the groove 42B of the polishing roll 41B is pressed against the end face of the lateral end of the ring body 23. The lateral end of the ring body 23 is thus polished and formed into a round shape. In the case where the ring body 23 is polished and rounded by using the polishing roll 41B of this modification, the lateral end of the ring body 23 can be formed into a semicircular shape with almost no edge if the thickness t of the ring body 23 satisfies the relationship t=2·r for the radius of curvature r of the groove 42B. However, there is actually a variation in thickness of the ring bodies 23. If the thickness t of the ring body 23 is t<2·r, edges may remain in both ends in the thickness direction of the end face of the ring body 23 (see FIGS. 10A, 10B). If the thickness t of the ring body 23 is t>2·r, both ends in the thickness direction of the end face of the ring body 23 may be polished by the outer peripheral surface of the polishing roll 41B other than the groove 42B, which may cause undercuts (see FIGS. 10C, 10D). In the present embodiment, the polishing roll is divided into the outer peripheral-side polishing roll 41 and the inner peripheral-side polishing roll 46, and the outer peripheral side and the inner peripheral side of each lateral end of the ring body 23 are polished into a round shape by the outer peripheral-side polishing roll 41 and the inner peripheral-side polishing roll 46. This allows both lateral ends of the ring body 23 to be formed into a semicircular shape with almost no edge regardless of the variation in thickness of the ring bodies 23.

The pre-rolling cleaning step (H) is a step of, before rolling the ring body 23, removing polishing debris etc. that has stuck to the ring body 23 in the polishing and rounding step. The rolling step (I) is a step of rolling the ring body 23 to a required thickness with a rolling roller to produce a ring body 24. As described above, the heat-affected zones with high hardness have been removed from the ring body 23 by the polishing and rounding step (G) after the ring cutting step. The ring body 23 can therefore be rolled to a desired thickness by the rolling step (I) without breakage. The post-rolling cleaning step (J) is a step of removing rolling oil etc. that has stuck to the ring body 24 by the rolling. The second solution treatment step (K) is a step of heating the ring body 24 produced by the rolling to recrystallize a metallic structure transformed by the rolling.

The circumference adjusting step (L) is a step of finely adjusting the circumferences of the ring bodies 24 produced by the rolling so that a plurality of the ring bodies 24 can be laminated in the radial direction. The aging and nitriding step (M) is a step of aging the ring bodies 24 with the adjusted circumferences and then nitriding the ring bodies 24 to strengthen the surfaces of the ring bodies 24.

The method for manufacturing a ring according to the embodiment described above is a method for manufacturing an endless metal ring for a continuously variable transmission using a transmission belt that is formed by binding a plurality of elements with the ring. The method includes the welding step (D) of butt welding the ends of a strip 21 to form an endless tubular body 22, the first solution treatment step (E) of solution-treating (annealing) the welded tubular body 22, the ring cutting step (F) of cutting the solution-treated tubular body 22 with laser light into ring bodies 23 with a predetermined width, and the polishing and rounding step (G) of polishing the lateral ends of the cut ring body 23 with a grinding wheel to remove the heat-affected zones formed by the ring cutting step (F) and form the lateral ends of the ring body 23 into a round shape. No heat-affected zone with high hardness therefore remains in the ring body 23 after the polishing and rounding step (G). This can eliminate the need to subsequently perform the first solution treatment step again and thus can improve ring manufacturing efficiency.

After the ring cutting step (F) is performed with a laser cutting machine, the heat-affected zones formed in the lateral ends of the ring body 23 by the laser cutting are also removed when the lateral end faces are processed into a round shape by the polishing and rounding step (G). Accordingly, even in the case where a cutting machine that is used in the ring cutting step (F) is switched from other cutting machine such as a cutter cutting machine to a laser cutting machine, a step of removing the heat-affected zones formed by the laser cutting needs only to be added to the polishing and rounding step (G). The existing facilities can therefore be effectively used, and additions and changes to manufacturing facilities can be minimized. That is, in the case where the heat-affected zones formed by the laser cutting are removed by solution treatment, a facility for solution-treating the ring body 23 is required. However, since the heat-affected zones are removed by the polishing and rounding step (G), such a facility need not be added.

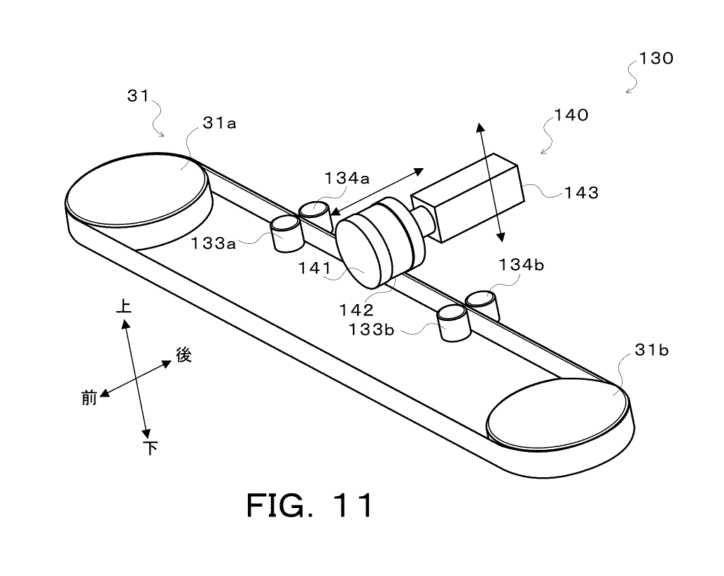

In the above embodiment, the polishing roll for the polishing and rounding step (G) is divided into the outer peripheral-side polishing roll 41 that polishes the outer peripheral side of an end of the ring body 23 and the inner peripheral-side polishing roll 46 that polishes the inner peripheral side of the end of the ring body 23. However, a lateral end of the ring body 23 may be polished and rounded by using the polishing roll 41B of the comparative example shown in FIG. 10. Alternatively, as shown in FIG. 11, the outer peripheral side and the inner peripheral side of an end of the ring body 23 may be polished and rounded by using an integrated polishing roll 141. FIG. 11 is a configuration diagram schematically showing the configuration of a polishing apparatus 130 of another embodiment. As shown in the figure, the polishing apparatus 130 of the another embodiment includes: a rotating unit 31 having a drive roller 31a and a driven roller 31b; a polishing unit 140 that polishes and rounds the outer peripheral side and the inner peripheral side of an end of the ring body 23; inner peripheral-side backup rollers 133a, 133b that are disposed in front of and behind the polishing unit 140 in a direction in which the ring body 23 is fed and support the ring body 23 from the inner peripheral side; and outer peripheral-side backup rollers 134a, 134b that are disposed in front of and behind the polishing unit 140 in the direction in which the ring body 23 is fed and support the ring body 23 from the outer peripheral side. The polishing unit 140 includes: a polishing roll 141 having an axis of rotation extending in a direction parallel to the thickness direction of the ring body 23 set on the rotating unit 31; and a rotating and moving unit 143 capable of rotating and moving the polishing roll 141 in the rotational direction of the polishing roll 141, the axial direction of the axis of rotation of the polishing roll 141 (forward and backward in the figure), and a direction perpendicular to this axial direction and parallel to the lateral direction of the ring body 23 (upward and downward in the figure).

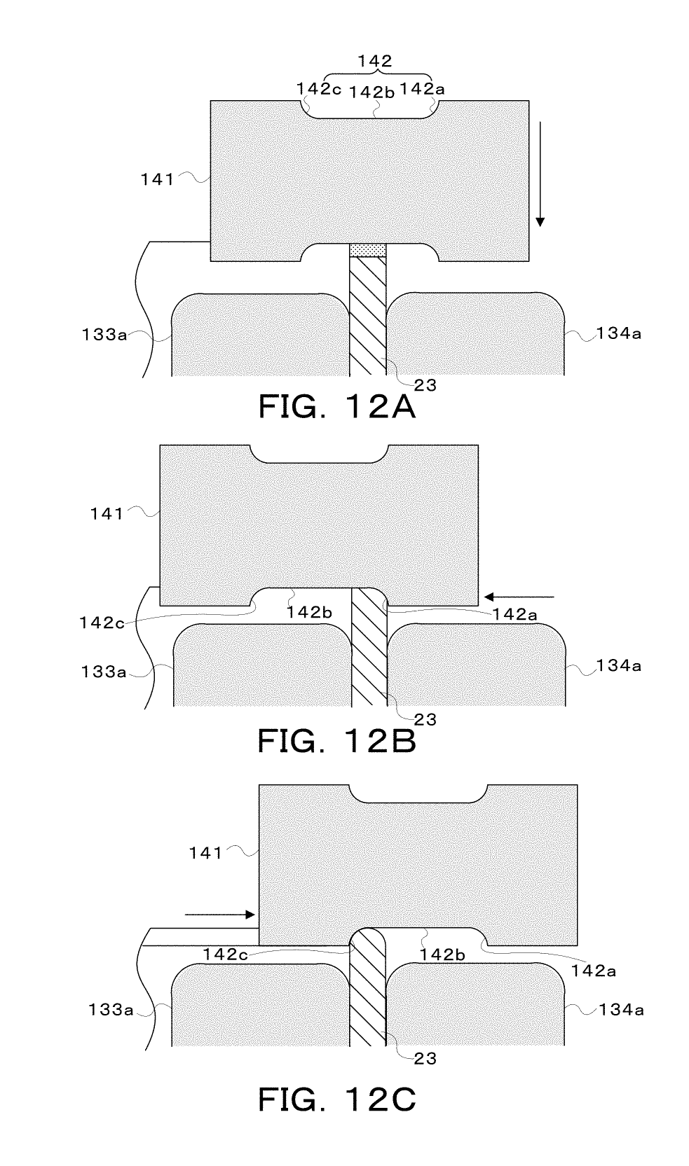

FIGS. 12A to 12C are illustrations showing how a lateral end of the ring body 23 is polished and rounded by using the polishing roll 141. In FIG. 12, a groove 142 of the polishing roll 141 is shown exaggerated for convenience of description. The polishing roll 141 is a columnar member and has the groove 142 formed in the circumferential direction in the middle of its outer peripheral surface in the axial direction along the entire circumference. The bottom of the groove 142 is formed by a linear portion 142b extending straight in the axial direction of the roll and both corners of the bottom of the groove 142 are formed by concave arc-shaped portions 142a, 142c having an arc angle θ of about 90 degrees and a radius of curvature r that is about ½ of the thickness t of the ring body 23. The groove 142 has an abrasive grain layer comprised of abrasive grains bonded together. The ring body 23 is polished and rounded by using the polishing roll 141 as follows. First, the polishing roll 141 is moved in a direction from one lateral end toward the other lateral end of the ring body 23 (downward in the figure) while being rotated, so that the linear portion 142b is pressed against the end face of the one lateral end of the ring body 23 to remove the heat-affected zone in the one lateral end of the ring body 23 (see FIG. 12A). The polishing roll 141 is then moved from the outer peripheral side toward the inner peripheral side in the thickness direction of the ring body 23 (to the left in the figure) while being rotated, so that the concave arc-shaped portion 142a is pressed against the outer peripheral side of the one lateral end (the outer peripheral side of the end) of the ring body 23. The outer peripheral side of the end of the ring body 23 is thus formed into a round shape (see FIG. 12B). The polishing roll 141 is then moved from the inner peripheral side toward the outer peripheral side in the thickness direction of the ring body 23 (to the right in the figure) while being rotated, so that the concave arc-shaped portion 142c is pressed against the inner peripheral side of the lateral end (the inner peripheral side of the end) of the ring body 23. The inner peripheral side of the end of the ring body 23 is thus formed into a round shape (see FIG. 12C). After the one lateral end of the ring body 23 is thus polished, the ring body 23 is removed from the rotating unit 31 and is mounted again on the rotating unit 31 with its one lateral end and the other lateral end switched, and the other lateral end of the ring body 23 is similarly polished. The heat-affected zones are thus removed from both lateral ends of the ring body 23, and both lateral ends of the ring body 23 are formed into a semicircular shape with almost no edge. The polishing unit 140 may be provided on each of the one lateral end side and the other lateral end side of the ring body 23 so that each of the one lateral end and the other lateral end of the ring body 23 is polished by a corresponding one of the polishing units 140. In that another embodiment, the inner peripheral side of the end of the ring body 23 is processed after the outer peripheral side of the end is processed. However, the outer peripheral side of the end of the ring body 23 may be processed after the inner peripheral side of the end is processed. The outer peripheral side and the inner peripheral side of the end of the ring body 23 may be alternately processed little by little at a time by repeatedly reciprocating the polishing roll 141 in the axial direction.

As described above, a method for manufacturing a ring according to the present disclosure is a method for manufacturing an endless metal ring (20) for a continuously variable transmission (1) using a transmission belt that is formed by binding a plurality of elements (11) with the ring. The method includes: a welding step (D) of butt welding ends of a metal strip (21) to form an endless tubular body (22); a solution treatment step (E) of solution-treating the welded tubular body (22); a cutting step (F) of cutting the solution-treated tubular body (22) with laser light into ring bodies (23) with a predetermined width; a lateral end processing step (G) of pressing a grinding wheel (41, 46) against a lateral end of the cut ring body (23) to remove a heat-affected zone formed by the cutting step (F) and form the lateral end into a convex arc shape; and a rolling step (I) of processing the lateral end to adjust the ring body (23) to a predetermined thickness.

In the method for manufacturing a ring according to the present disclosure, after the welding step (D) of forming the endless tubular body (22), the first solution treatment step (E) of solution-treating the tubular body (22), and the cutting step (F) of cutting the tubular body (22) into ring bodies (23) by laser cutting are performed, the heat-affected zone formed by the laser cutting is also removed when the lateral end of the ring body (23) is formed into a convex arc shape by the lateral end processing step (G). No heat-affected zone with high hardness therefore remains in the ring body (23) after the lateral end processing step (G). This can eliminate the need to subsequently perform the first solution treatment step (E) again and thus can improve ring manufacturing efficiency. After the cutting step (F) is performed with laser light, the heat-affected zone formed in the lateral end of the ring body (23) by the laser cutting is also removed when the lateral end is processed into a convex arc shape by the lateral end processing step (G). Accordingly, even in the case where a cutting machine that is used in the cutting step (F) is switched from other cutting machine such as a cutter cutting machine to a laser cutting machine, the existing facilities can be effectively used, and additions and changes to manufacturing facilities can be minimized.

The method for manufacturing a ring according to the present disclosure may further include: a second solution treatment step (K) of solution-treating the ring body (24) adjusted to the predetermined thickness; a circumference adjusting step (L) of adjusting a circumference of the solution-treated ring body (24); and an aging and nitriding step (M) of aging and nitriding the ring body (24) with the adjusted circumference. The heat-affected zone formed in the cutting step (F) described above is removed by the polishing step (G). Accordingly, the solution treatment step (E) is not subsequently performed again, and the ring body (23) can be restrained from breaking when the ring body (23) is rolled in the rolling step (I) or the circumference of the ring body (23) is adjusted in the circumference adjusting step (L). Satisfactory processing accuracy can thus be achieved.

In the method for manufacturing a ring according to the present disclosure, the lateral end processing step (G) may be a step in which the ring body (23) under tension is rotated in a circumferential direction, and a concave arc-shaped grinding wheel (42a, 142a) is pressed against the lateral end of the ring body (23) from an outer peripheral side toward an inner peripheral side in a thickness direction of the ring body (23) to form the outer peripheral side of the lateral end of the ring body (23) into a convex arc shape, and a concave arc-shaped grinding wheel (47a, 142c) is pressed against the lateral end of the ring body (23) from the inner peripheral side toward the outer peripheral side in the thickness direction of the ring body (23) to form the inner peripheral side of the lateral end of the ring body (23) into a convex arc shape. The lateral end (the outer peripheral side and the inner peripheral side of the end) of the ring body (23) can thus be formed into a semicircular shape with almost no edge even if there is a variation in thickness of the ring bodies (23).

Although the embodiments of the invention of the present disclosure are described above, it is to be understood that the invention of the present disclosure is not limited in any way to the embodiments and may be carried out in various forms without departing from the spirit and scope of the invention of the present disclosure.

### INDUSTRIAL APPLICABILITY

The various aspects of the present disclosure can be utilized in manufacturing industries of transmission belts for use in continuously variable transmissions.

1. A method for manufacturing an endless metal ring for a continuously variable transmission using a transmission belt that is formed by binding a plurality of elements with the ring, comprising:
a welding step of butt welding ends of a metal strip to form an endless tubular body; a solution treatment step of solution-treating the welded tubular body; a cutting step of cutting the solution-treated tubular body with laser light into ring bodies with a predetermined width; a lateral end processing step of pressing a grinding wheel against a lateral end of the cut ring body to remove a heat-affected zone formed by the cutting step and form the lateral end into a convex arc shape; and a rolling step of adjusting the ring body with the processed lateral end to a predetermined thickness.

2. The method for manufacturing a ring according to claim 1, further comprising:
a second solution treatment step of solution-treating the ring body adjusted to the predetermined thickness; a circumference adjusting step of adjusting a circumference of the solution-treated ring body; and an aging and nitriding step of aging and nitriding the ring body with the adjusted circumference.

3. The method for manufacturing a ring according to claim 1, wherein
in the lateral end processing step, the ring body under tension is rotated in a circumferential direction, and a concave arc-shaped grinding wheel is pressed against the lateral end of the ring body from an outer peripheral side toward an inner peripheral side in a thickness direction of the ring body to form the outer peripheral side of the lateral end of the ring body into a convex arc shape, and a concave arc-shaped grinding wheel is pressed against the lateral end of the ring body from the inner peripheral side toward the outer peripheral side in the thickness direction of the ring to form the inner peripheral side of the lateral end of the ring body into a convex arc shape.

4. The method for manufacturing a ring according to claim 2, wherein
in the lateral end processing step, the ring body under tension is rotated in a circumferential direction, and a concave arc-shaped grinding wheel is pressed against the lateral end of the ring body from an outer peripheral side toward an inner peripheral side in a thickness direction of the ring body to form the outer peripheral side of the lateral end of the ring body into a convex arc shape, and a concave arc-shaped grinding wheel is pressed against the lateral end of the ring body from the inner peripheral side toward the outer peripheral side in the thickness direction of the ring to form the inner peripheral side of the lateral end of the ring body into a convex arc shape.
